(19) United States
(12) Patent Application Publication
(10) Pub. No.: US 2026/0321156 A1
(43) Pub. Date: Oct. 15, 2026

(54) MACHINE LEARNING-BASED PHONETICS EVALUATION PLATFORM

(71) Applicant: 95 Percent Group LLC, Lincolnshire, IL (US)

(72) Inventors: Susan Jeanne Adelmann, Lake in the Hills, IL (US); George J. Gatsis, Bull Valley, IL (US); Jennifer Christine Harris, Scituate, MA (US); Dmitriy Khots, Omaha, NE (US); Jesse Michael Moore, Calgary (CA); Alvaro Alberto Chernez Viteri, Toronto (CA); William Howard Scarlett, Habrough (GB)

(21) Appl. No.: 19/179,716

(22) Filed: Apr. 15, 2025

(51) Int. Cl. G09B 17/00; G10L 15/02; G10L 15/187; G10L 15/26; G10L 25/27

(52) U.S. Cl. CPC G09B 17/003; G10L 15/02; G10L 15/187; G10L 15/26; G10L 25/27; G10L 2015/025

(57) ABSTRACT

The present technology provides for an automated phonetic evaluation system for assessing early literacy skills in students. The system receives audio data of a student attempting to pronounce a pseudoword, processes it using a machine-learning model to determine a phoneme-based transcription, and compares it to one or more sets of acceptable phonemes associated with the pseudoword. If the teacher score mark and the model score mark differ, the system provides feedback to a client device indicating the discrepancy. The system can also receive follow-up feedback from a teacher and fine-tune its parameters to correct misalignments.

### BACKGROUND

Many teachers, especially new teachers, lack adequate training in how to effectively use tools to help students learn phonics. This can make it challenging for them to properly diagnose and address gaps in a student's phonetic skills. Some current systems involve teachers administering a diagnostic evaluation with different phonics skills, then manually scoring the student's performance. However, teachers sometimes struggle to accurately score these evaluations, leading to difficulties in identifying the right interventions to support the student.

Accordingly, there is a need to provide teachers, especially those with limited phonics training, with a tool that can simplify and improve the accuracy of scoring student performance on these phonics evaluations. Such a system would reduce the burden on teachers while improving the accuracy and consistency of phonics evaluations, ultimately supporting the development of foundational literacy skills in early learners.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a system architecture of an example phonetic evaluation system in accordance with some aspects of the present technology.

FIG. 2A and FIG. 2B illustrate an example flow diagram for the phonetic evaluation service in accordance with some aspects of the present technology.

FIG. 3 illustrates a workflow for training a machine-learning model that processes audio recordings to generate transcripts and evaluations of pseudoword pronunciations in accordance with some aspects of the present technology.

FIG. 4 illustrates an example graphical user interface for evaluating a practice assessment in accordance with some aspects of the present technology.

FIG. 5 illustrates an example graphical user interface for evaluating a practice assessment in accordance with some aspects of the present technology.

FIG. 6 illustrates an example graphical user interface of a transcription editor in accordance with some aspects of the present technology.

FIG. 7 illustrates an example graphical user interface of a student profile and assessment history in accordance with some aspects of the present technology.

FIG. 8 illustrates an example method of a machine learning-based phonetics evaluation platform in accordance with some aspects of the present technology.

FIG. 9 illustrates a block diagram of an exemplary computing system in accordance with some aspects of the present technology.

FIG. 10 illustrates an example neural network architecture in accordance with some aspects of the present technology.

### DETAILED DESCRIPTION

Traditional phonetic diagnostic evaluations for early readers are performed in a classroom setting by educators, who face challenges navigating distractions such as classroom noises and other children's activities while trying to focus on the child who may potentially need literacy intervention. These evaluations have historically been time-consuming and labor-intensive, requiring paper-based administration and scoring. Current phonetic diagnostic evaluations for early readers are often plagued by limitations, including a lack of efficiency and accuracy in identifying students who require extra help. This is particularly true when it comes to distinguishing between students who need additional support and those who do not. Furthermore, current evaluations may struggle to identify problematic skill levels, particularly in cases where the teacher may have misheard spoken words or lacked prior experience with decoding text characters.

The need exists for improved diagnostic tools that can assist educators in identifying early readers who require extra help and diagnosing specific intervention needs. These tools should be able to automate time-consuming evaluations, enabling teachers to focus on delivering high-value instruction to more students. However, current speech AI systems used for reading, decoding, and pronunciation evaluation tasks have limitations that make them unsuitable for this purpose.

For example, these systems have largely been trained on adult audio recordings from quiet rooms without background noise, which can lead to poor performance on word-or phoneme-error rate metrics when attempting to assess young children's reading pseudowords in noisy environments. Additionally, current systems often struggle to recognize pseudowords read by young readers at the phoneme level, considering both articulation and grapheme-to-phoneme common errors. Furthermore, they may not be able to separate multiple speakers when using single-channel audio recording, and eliminating background noise can be a challenge.

Pseudowords are made up words that are designed to test specific phonetic patterns and skills, such as a pseudoword “whob” which is used to test for the correct pronunciation of the “wh” digraph sound. Pseudowords provide a controlled set of stimuli to assess the student's phonetic awareness and decoding abilities. Pseudo words are used because they are not recognizable on sight words, to ensure that students have the skill to decode versus memorization, which is a central tenet of structured literacy (versus balanced literacy, where context cues are encouraged).

The present technology discloses an AI-based phonetic diagnostic evaluation for early readers, combining teacher observation with automation efficiency. Through a custom AI model development and tuning, proprietary corpus of child recordings for model testing, and enabling the system to recognize pseudowords read by young readers at the phoneme level, considering both articulation and grapheme-to-phoneme common errors.

The system also includes a teacher-facing interface designed to efficiently augment and improve teacher observational skills. This interface enables teachers to easily review and analyze evaluation results, identify areas for intervention, and tailor instruction to meet individual students' needs. By combining the strengths of human observation with the efficiency and accuracy of automated evaluations, the present invention provides a significant improvement over current phonetic diagnostic evaluations for early readers, enabling educators to quickly and accurately identify students who require extra help and diagnosing specific intervention needs.

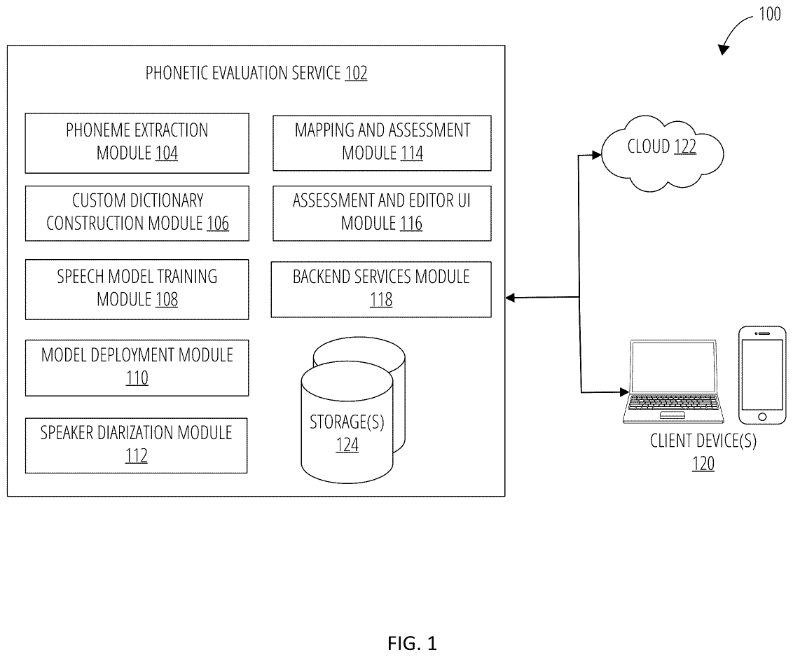

FIG. 1 illustrates a system architecture of an example machine learning-based phonetic evaluation system in accordance with some aspects of the present technology.

The phonetic evaluation system 100 may provide real-time feedback to teachers regarding areas where students may be struggled with phonemes (sounds) and grapheme decoding (the process of mapping sounds to letters). First, the phonetic evaluation service 102 may evaluates early readers' pronunciation accuracy and grapheme decoding proficiency on phonemes by identifying areas where students need targeted support. Additionally, the phonetic evaluation system 100 may analyze results of a diagnostic test and compare the results to the teacher's score. If there are any discrepancies, the phonetic evaluation service 102 may alert teachers to areas of concern by highlighting specific words and sounds where the results from a diagnostic test deviates from an evaluation of a student's skill and proficiency.

The phonetic evaluation service 102 may include a phoneme extraction module 104, a custom dictionary construction module 106, a speech model training module 108, a model deployment module 110, a speaker diarization module 112, a mapping and assessment module 114, an assessment and editor UI module 116, and a backend services module 118.

The phoneme extraction module 104 may extract individual phonemes from audio recordings. Phonemes are the smallest units of sound in language, such as /ch/ or /a/. Phonemes are not just letters-they are also unique sounds made by combinations of letters. The phoneme extraction module may use machine learning algorithms to identify and extract these sound units from the audio data.

The custom dictionary construction module 106 may construct and/or maintain customized dictionaries for phonetic screening purposes. The custom dictionaries may be tailored to a respective language and skill levels being assessed, ensuring that it accurately represents the sounds and word patterns being evaluated. For example,

The speech model training module 108 may train speech models using data from the custom dictionary constructed by the custom dictionary construction module 106. The goal is to create accurate models that can predict how children will pronounce specific words and sounds. The speech model training module 108 may involve machine learning techniques such as supervised or unsupervised learning, where a machine-learning model is trained on labeled datasets of correct pronunciations and incorrect ones to learn patterns and relationships between sounds and speech.

The model deployment module 110 may deploy the trained speech models from the speech model training module 108 into production-ready environments. This might involve integrating the models with other components of the phonetic screening system, such as the mapping and assessment module 114 or the backend services module 118

The speaker diarization module 112 may be responsible for distinguishing between multiple speakers in an audio recording. In the context of phonetic screening, this means identifying which child's voice is being heard and excluding any background voices or interferences from teachers or other adults. The speaker diarization module 112 may employ speaker recognition techniques such as source separation or independent component analysis to separate individual voices and prioritize the child's audio for further processing. In some cases, if the client device(s) 120 are equipped with dual channel recording, then speaker diarization may not be needed, which will save compute resources and speed up processing.

The mapping and assessment module 114 may take the processed audio data from the phoneme extraction module 104, custom dictionary construction module 106, and speech model training module 108 and use the processed audio data to assess a child's pronunciation skills. The mapping and assessment module 114 may employ machine learning algorithms to evaluate the accuracy of the child's pronunciations against expected standards or benchmarks. This could involve providing feedback to teachers or parents about areas for improvement in the child's pronunciation skills.

The assessment and editor UI module 116 may provide a user interface for transcribing and viewing the original audio recordings used during phonetic screening evaluations. It might include features such as playback, pause, and rewind controls, as well as text editing capabilities for annotating or labeling specific segments of the recording. The interface may be used for reinforcement training by skilled linguists to improve the speech models.

The backend services module 118 may provide a range of backend services that support the phonetic screening process. This could include data storage, API integration, and other administrative functions necessary for managing the phonetic evaluation service 102. Without direct definition, this module might involve integrating with external systems or APIs to provide additional functionality, such as data analytics or reporting tools.

The phonetic evaluation system 100 may include a phonetic evaluation service 102 that interfaces with the cloud 122 and client device(s) 120. The phonetic evaluation service 102 may rely on Internet connectivity in some cases and may operate offline or partially offline in other cases. The client device(s) 120 may include mobile devices, desktop computers, laptops, and other devices that include microphone capabilities.

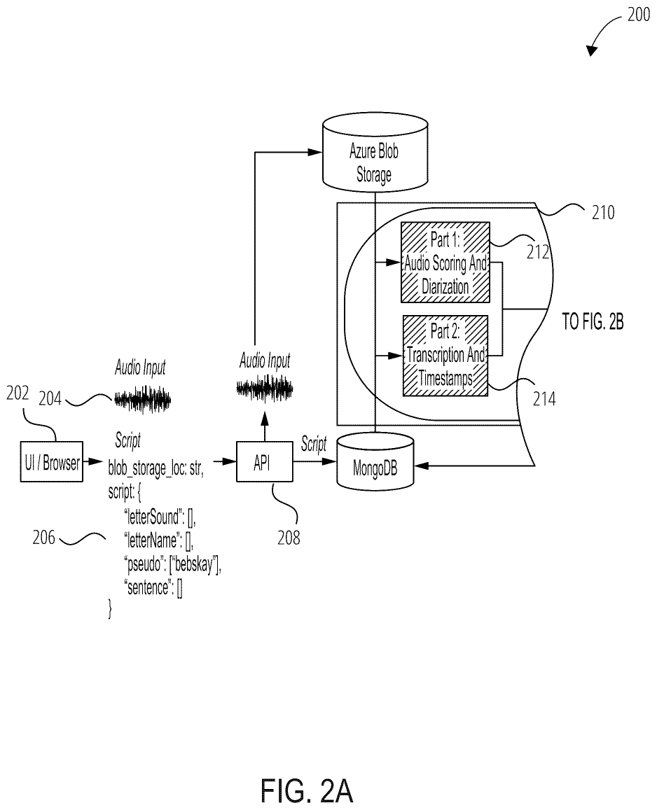

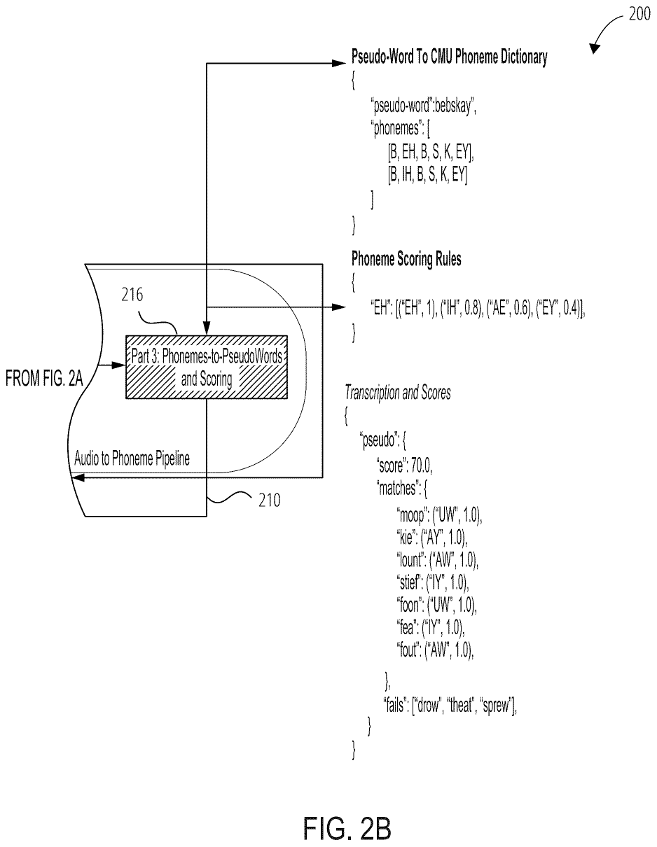

FIG. 2A and FIG. 2B illustrate an example flow diagram for the phonetic evaluation service 102 in accordance with some aspects of the present technology.

The example flow diagram 200 for the phonetic evaluation service 102 illustrates a high-level workflow and showcasing interactions between the various modules of the phonetic evaluation service 102.

A user interface 202 accessible by a student and/or a teacher at a client device(s) 120 may capture an audio recording of an observational evaluation. The audio recording may be generated into an audio input 204. The script input 206 may be a script containing the one or more pseudowords that the student is attempting to pronounce in the audio input 204. Typically, each audio input 204 and respective script input 206 may be specific to a particular skill, such as a particular set of phonemes.

An audio input 204 and a script input 206 may be provided to an Application Programming Interface (API) 208. The API 208 may send the audio input 204 and the script input 206 to storage(s) 124, which may be a single shared storage or different storages, respectively. In some cases, the audio input 204 is stored in a scalable object storage service that manages unstructured data and the script input 206 may be stored in a document-based database and can also be used as a queuing mechanism, indicating that a new record has been inserted for processing. The storage(s) 124 may be a part of the phonetic evaluation service 102 and/or may partially or fully be cloud-based databases.

In some cases, a pre-trained base model 210 may include a pre-trained Natural Language Processing (NLP) model that can be fine-tuned on a specific task or dataset related to phonetic screening, such as evaluating the pronunciation quality of students pronouncing pseudowords, in order to adapt its performance to the requirements of phonetic evaluation service 102. The pre-trained base model 210 may be loaded for the phonetic evaluation service 102 such that the storage(s) 124 may interface with the pre-trained base model 210. The pre-trained base model 210 may be trained to process an audio input 204 and a script input 206 and output a phonetic transcription of the audio input 204.

The script input 206 may include the pseudoword(s) that the student is attempting to pronounce in the audio input 204. In some cases, the script input 206 may also include other features, such as phoneme-based transcriptions of the pseudoword(s), such as:
1. letterSound: this section contains a list of phonetic symbols (e.g., /p/, /t/, /k/).
2. letterName: this section contains a list of phonetic spellings of letters (e.g., “b”, “d”, “g”).
3. pseudo: this section contains a single pseudoword or phrase that is being transcribed (in the example case provided in FIG. 2A, “bebskay”).

If the script input 206 includes the phoneme-based transcriptions, the script input 206 may be generated based on a reference to a phoneme-to-pseudoword custom dictionary (or another external dictionary or source) that maps the pseudowords to phonemes transcriptions. The phoneme-to-pseudoword custom dictionary and/or other external dictionaries or resources may be integrated and/or accessed by the custom dictionary construction module 106.

In some cases, the script input 206 may provide a framework for transcribing and processing the audio input 204, but it may not contain any actual phonetic transcriptions or labels. The actual phonetic transcriptions or labels may be stored separately in the storage(s) 124 or may be determined by the pre-trained base model 210. Ultimately, the script input 206 triggers the phonetic evaluation service 102 to generate a transcription or labeling of the audio input 204.

For example, the phoneme /p/ might correspond to the pseudowords “pat”, “pad”, and “pet”, and the phoneme /t/ might correspond to the pseudowords “tot”, “tap”, and “top”. By analyzing the audio input 204, the pre-trained base model 210 may use the script input 206 and/or a phoneme-to-pseudoword custom dictionary to identify which phonemes are present in the audio input 204. In some cases, the script input 206 may also reference a particular dictionary containing pseudo-word-to-transcription mappings to use. For example, there may be different dictionaries for different languages.

In some cases, the phoneme extraction module 104 and/or the pre-trained base model 210 in phase one 212 may assess the audio input 204 for quality and can be rejected if the audio input 204 is deemed unqualified (e.g., there's too much background noise, no audio, the student's voice is too quiet, the audio is in a different language, etc.). In the case that the audio input 204 originates from a single channel with multiple speakers (e.g., the teacher's instructions are also captured within it), the phonetic evaluation service 102 may use the speaker diarization module 112 to differentiate between the speakers and focus pronunciation scoring to only the audio associated with the student's voice. This is important because the evaluation is often with young students and require instructional dialogue with the teacher.

Based on the audio input 204 and the script input 206, the phoneme extraction module 104 and/or the pre-trained base model 210 in phase two 214 may build a phoneme transcript of the elements pronounced by the student. In some cases, the phoneme extraction module 104 uses techniques such as spectral features, acoustic models, and machine learning algorithms to identify the phonemes. The phoneme extraction module 104 and/or the pre-trained base model 210 in phase two 214 may add timestamps to each phoneme which can later be used within the user interface 202 for playback of exact spots within the recording, and helps highlight to the teacher regarding which pseudowords require more attention

The mapping and assessment module 114 and/or the pre-trained base model 210 in phase three 216 may assess the extracted phonemes of the phoneme transcript in view of expected phonemes of the expected pseudoword by using the phoneme-to-pseudoword custom dictionary, which may include several acceptable pronunciations of each pseudoword. The mapping and assessment module 114 and/or the pre-trained base model 210 in phase three 216 may assess the mapped phonemes and respective pseudowords based on phoneme scoring rules. The mapping and assessment module 114 and/or the pre-trained base model 210 in phase three 216 may output the transcription and score for each pseudoword, which will then load completed results back into the storage(s) 124 and mark the record as processed so that downstream services can process the record and visualize the output back within the user interface 202 on client device(s) 120.

As shown in FIG. 2A, the pseudoword of the inputted audio input 204 is “bebskay”, and has two sets of acceptable phonemes-based pronunciations: [B, EH, B, S, K, EY], [B, IH, B, S, K, EY]. The phoneme scoring rules provide additional information on how to weight the scores of each phoneme, and help to refine the pre-trained base model 210 to prediction and produce more accurate scores. As shown in FIG. 2A, the transcription and scores output sent back to the storage(s) 124 includes {“pseudo”: {“score”: 70.0, “matches”: {“moop”: [“UW”, 1.0], “kie”: [“AY”, 1.0], “lount”: [“AW”, 1.0], “stief”: [“TY”, 1.0], “foon”: [“UW”, 1.0], “fea”: [“IY”, 1.0], “fout”: [“AW”, 1.0] }}, “fails”: [“drow”, “thear”, “sprew”]}}, which indicates that the student pronounced the selected phoneme of “moop”, “kie”, “lount”, “stief”, “foon”, “fea”, “fout” correctly but did not pronounce the selected phoneme for “drow”, “thear”, or “sprew”. The student will not have needed to pronounce the entire pseudoword correctly, just the selected phoneme, which for the correct pseudowords were “UW”, “AY”, “AW”, “TY”, “UW”, “IY”, and “AW”, respectively.

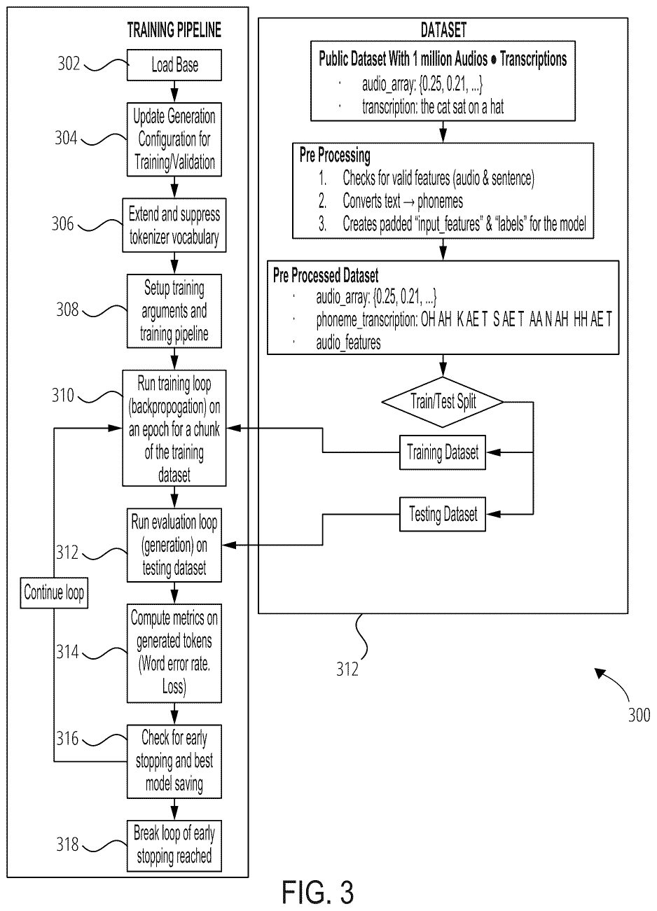

FIG. 3 illustrates a workflow for training a machine-learning model that processes audio recordings to generate transcripts and evaluations of pseudoword pronunciations in accordance with some aspects of the present technology.

In some cases, in block 302 of an example workflow, a pre-trained base model 210 from a repository may be loaded. The pre-trained base model 210 may serve as a foundation for generating the transcripts and evaluations of pseudoword pronunciations. The pre-trained base model 210 may be trained on a dataset 303 based on large datasets of audio recordings and corresponding transcriptions, in which the pre-trained base model 210 captures patterns in speech associated with pseudoword pronunciations. In some cases, the pre-trained base model 210 is a speech-to-text machine-learning model.

In some cases, after loading the pre-trained base model 210, in block 304, a generation configuration is updated. Updating the generation configuration may involve adjusting hyperparameters such as learning rates or batch sizes to optimize performance and fine-tune the pre-trained base model 210 to better suit the specific requirements of the evaluation.

In some cases, in block 306, a tokenizer vocabulary may be extended or suppressed. The tokenizer vocabulary may represent a mapping between audio inputs and their corresponding phoneme sequences used during training, or a way of representing the audio input 204 as a series of discrete units (phonemes) that can be processed by the pre-trained base model 210. In some cases, additional phonemes may be required to capture nuances in speech patterns, while others may be redundant and can be removed to improve performance. The ‘extend’ process adds new tokens to the vocabulary, allowing the model to learn from a wider range of inputs. On the other hand, the ‘suppress’ process may remove unnecessary or redundant tokens from the vocabulary, which can help reduce computational costs and improve model efficiency.

For example, if the original vocabulary included only 10 phonemes, extending it by adding 5 more might help the model recognize more complex patterns in the data. This could involve using a larger set of phoneme combinations. For example, if the original vocabulary included phonemes like /p/, /t/, and /k/, extending it might also include phonemes like /f/, /v/, and /s/. If the original vocabulary only allowed sequences of 2-3 phonemes, extending it to allow longer sequences (e.g. 4-5 phonemes) might help the model learn more complex patterns in the data. On the other hand, suppressing the vocabulary means removing less common or unlikely phonemes from the mapping to help the model focus on more common patterns in the data. If the original vocabulary included a large number of rare phonemes, suppressing them might allow the model to generalize better. For instance, if the original vocabulary included the phoneme/y/, suppressing it might enable the model to learn more generalizable patterns.

With the updated configuration in place, the next step may be setting up training arguments and a training pipeline in block 308. Block 308 may involve defining an architecture of the pre-trained base model 210, data loading, and optimization algorithms, such as stochastic gradient descent (SGD) or Adam. The training pipeline may be designed to efficiently process large datasets and update the model's parameters, such as using backpropagation.

In block 310, a training loop may begin by initializing weights and biases, followed by forward passes through the network. In block 310, the pre-trained base model 210 may process a chunk of the training dataset, generating predictions for each input. Backward passes compute gradients using the loss function, which measures the difference between predicted and actual outputs. The gradients are then used to update the model's parameters using optimization algorithms. After completing an epoch, in block 312, the evaluation loop takes over to generate new predictions for a portion of the training dataset. This allows the pre-trained base model 210 to be evaluated on its performance without requiring additional training data in block 314, during which metrics such as word error rate (WER) and loss are computed to evaluate the performance of the pre-trained base model 210.

To prepare the training dataset, audio features are extracted from each input. The resulting audio features may then be converted to phonemes using the tokenizer vocabulary, which is updated during the ‘extend’ process. Once the data has been prepared, it can be fed into the training pipeline. The preprocessed dataset may include input features and labels, with each label corresponding to a specific output or transcription. The training pipeline may process the preprocessed dataset in batches, updating the parameters of the pre-trained base model 210 using backpropagation until early stopping is reached or a predetermined number of epochs has passed.

Early stopping in block 316 is an important mechanism for preventing overfitting during training. It involves monitoring the performance of the pre-trained base model 210 on a validation set and stopping training when the WER or loss stops improving. As such, the pre-trained base model 210 is may break the loop when early stopping is reached in block 318 to prevent from becoming too specialized to the training data, allowing it to generalize better to unseen inputs. The training process is iterative, with each epoch building upon the previous one to refine the model's performance over time.

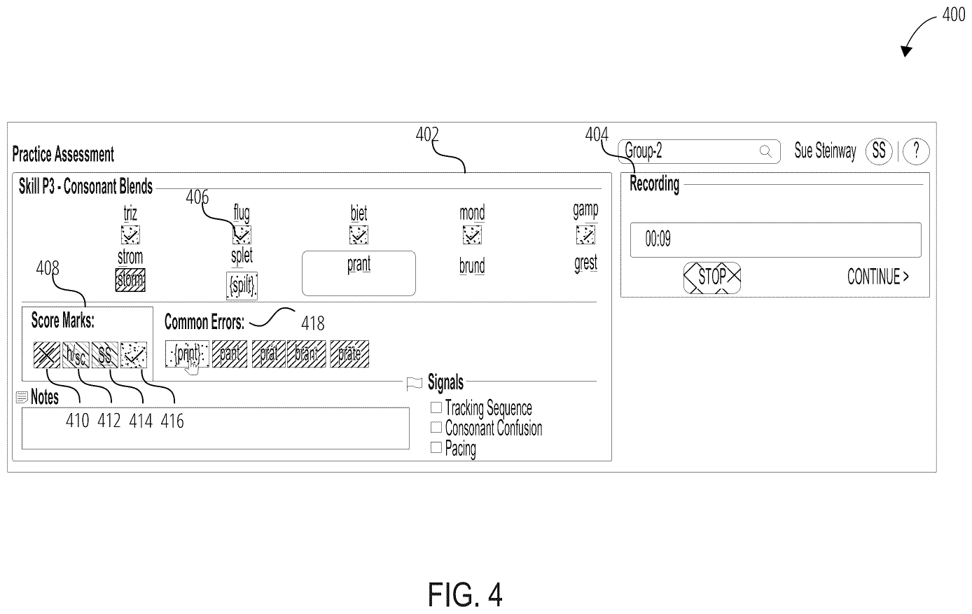

FIG. 4 illustrates an example graphical user interface for evaluating a practice assessment in accordance with some aspects of the present technology.

The graphical user interface 400 for a practice evaluation that a teacher would be viewing while a student is taking the practice evaluation may include a skills complete panel 402 and a recording panel 404.

The skills complete panel 402 may include various pseudoword icons 406 that represent the pseudowords that were a part of the practice evaluation. The teacher may select a score mark 408, which may be a score of: incorrect 410, h/sc 412, ss 414, or correct 416. The ‘h/sc’ stands for ‘Hesitation/Self-Correction, while ‘ss’ stands for Sound-by-Sound. These are two common articulation patterns that are observed and need to handle as students are learning to read. They are considered acceptable responses.

The skills complete panel 402 may also include a selection for common errors 418 associated with a pseudoword of a selected pseudoword icon 406. As the teacher is listening to the recording, the teacher may select one of the common errors 418 and/or a score mark 408 as well as enter notes and other signals for their assessment of the pronunciation of each pseudoword in a practice assessment.

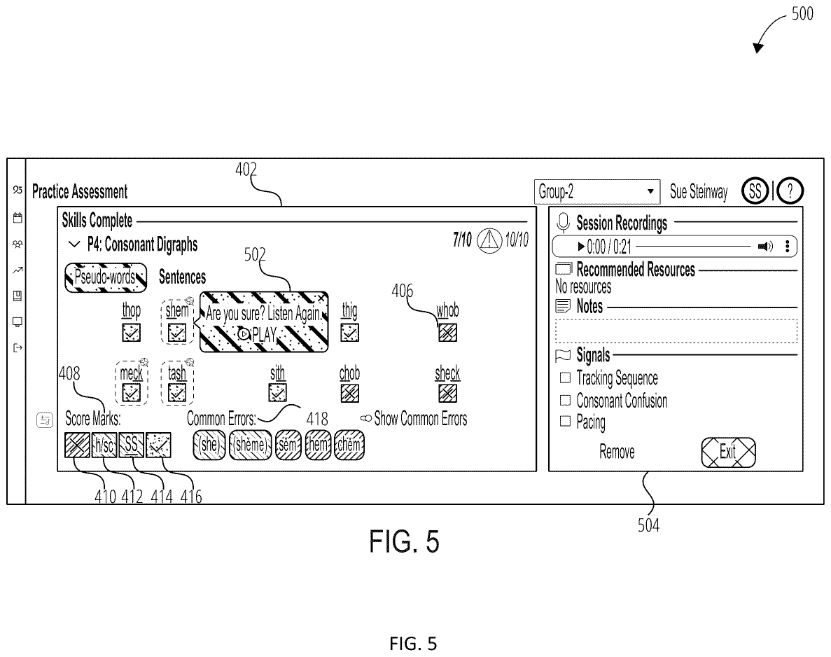

FIG. 5 illustrates an example graphical user interface for evaluating a practice assessment in accordance with some aspects of the present technology.

As shown in FIG. 5, as shown with the pseudowords “shem”, “whob”, “mock”, “tash”, and “shock”), pseudowords may be highlighted or circled to indicate that the phonetic evaluation system 100 has determined a different score mark 408. In some cases, a pop-up 502 asks whether the user wants to listen to the recording of the student speaking the pseudoword again.

The secondary panel 504 may include an audio playback that includes controls for playing and pausing the audio recording. The secondary panel 504 may also include recommended resources pertaining to the selected pseudoword icon 406. The secondary panel 504 may include a field to enter notes and also tags to select, such as “tracking sequence”, “consonant confusion”, and “pacing”, to help categorize and narrow down the issues that the student might have.

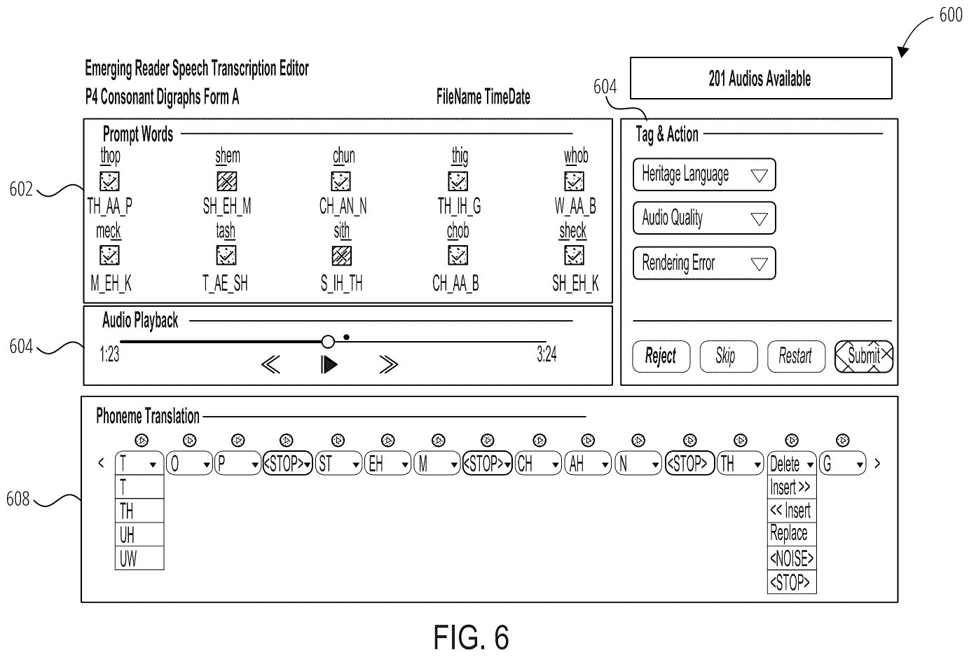

FIG. 6 illustrates an example graphical user interface of a transcription editor in accordance with some aspects of the present technology.

The graphical user interface 300, which may be controlled by the assessment and editor UI module 116, may present a prompt words panel 302 that shows various pseudowords that are part of an evaluation. For each pseudoword, there may be an underlined or highlighted phoneme that is the target for the evaluation, whereby if the a student pronounces that phoneme correct and pronounces the rest of the word incorrectly, it is still considered correct.

As shown in FIG. 6, in the prompt words panel 302 the student pronounced “TH” in “thop” correct, “SH” in shem incorrectly, “CH” in “chun” correctly, “TH” in “thig” correctly, “WH” in “whob” correctly, “CK” in “mock” correctly, “SH” in “tash” correctly, “TH” in “sith” incorrectly, “CH” in “chob” correctly, and “SH” and “CK” in “shock” correctly.

The graphical user interface 600 may include an audio playback panel 604 that includes controls for playing the audio recording. A user can press play/pause and traverse the full audio recording using progress controls.

The graphical user interface 600 may also include a phoneme translation panel 608 that includes a way for users to review the transcriptions, where users can delete, add, or replace a phoneme to ensure the audio transcription is correct by using a fully scrollable and searchable list of available phonemes may be provided. In some cases, the review process de-identifies student information. In order to drive accuracy improvements in the pre-trained base model 210, the assessment and editor UI module 116 receives the corrections and may be sent to the speech model training module 108 for continued model training.

The graphical user interface 600 may also include a tagging panel 606 that includes various tags that can be added, such a heritage language, audio quality, and rendering error.

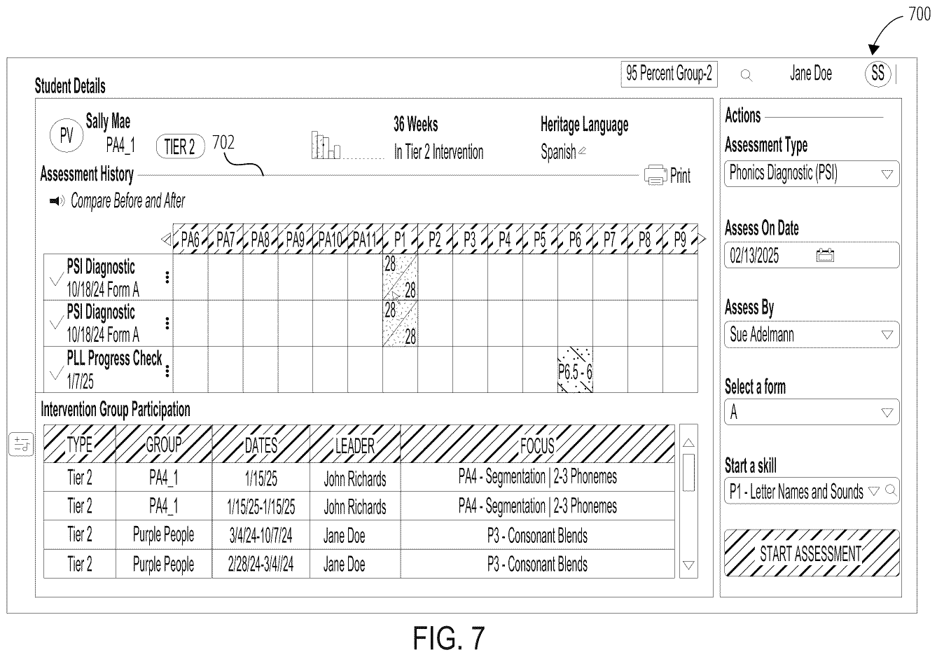

FIG. 7 illustrates an example graphical user interface of a student profile and assessment history in accordance with some aspects of the present technology.

The graphical user interface 700 shows a student's progress in their different assessments in an assessment history module 702 that are focused on different phonemes, consonant blends, and other categories.

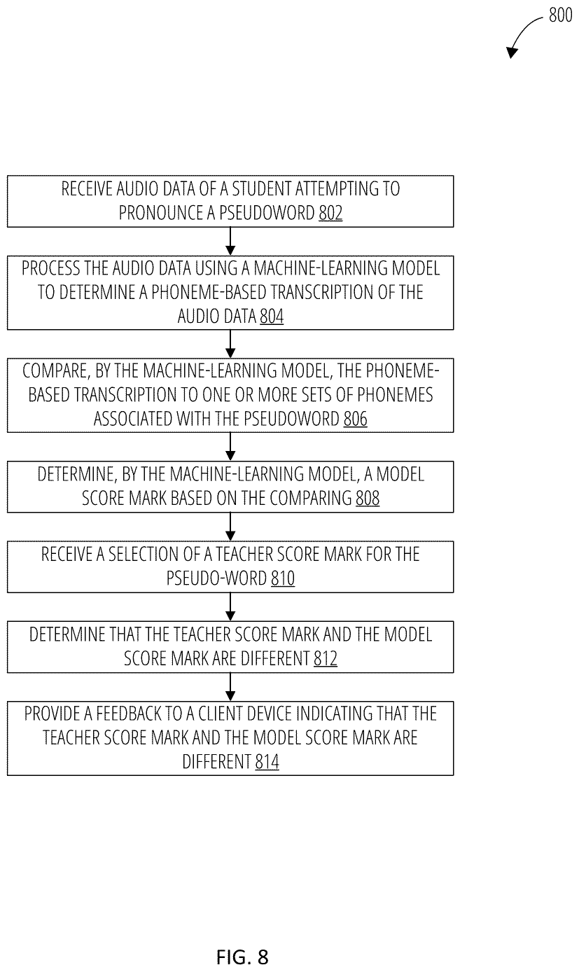

FIG. 8 illustrates an example method 800 of a machine learning-based phonetics evaluation platform in accordance with some aspects of the present technology. Although the example method 800 depicts a particular sequence of operations, the sequence may be altered without departing from the scope of the present disclosure. For example, some of the operations depicted may be performed in parallel or in a different sequence that does not materially affect the function of the method 800. In other examples, different components of an example device or system that implements the method 800 may perform functions at substantially the same time or in a specific sequence.

According to some examples, the method includes receiving audio data of a student attempting to pronounce a pseudoword at step 802. For example, the phonetic evaluation system 100 in FIG. 1 may receive the audio data from the client device(s) 120. In some cases, the audio data includes the student attempting to pronounce multiple pseudowords. In some cases, the phonetic evaluation system 100 is used by trained linguists who are over-scoring assessments given by teachers to students.

In some cases, the audio data comes from pre-processed audio data of the student attempting to pronounce the pseudoword and a teacher speaking. The speaker diarization module 112 may perform speaker diarization on the pre-processed audio data, such that the audio data of the student attempting to pronounce the pseudoword is isolated from audio data of the teacher speaking.

According to some examples, the method includes processing the audio data using a machine-learning model to determine a phoneme-based transcription of the audio data at step 804. For example, the phoneme extraction module 104, the phonetic evaluation service 102, and/or the pre-trained base model 210 of FIGS. 1 and 2 may process the audio data. The machine-learning model may determine the phoneme-based transcription by using a tokenizer vocabulary that represents a mapping between audio inputs and corresponding phonemes.

The tokenizer vocabulary may be created through a process called tokenization, where the audio data is segmented into smaller units, such as acoustic features or spectrogram frames, which are then mapped to specific phonemes in the vocabulary. The resulting vocabulary can be thought of as a finite set of discrete values that represent the possible phoneme assignments for each audio input. For instance, if the vocabulary contains 50 unique phonemes, it means that the model is able to distinguish between these 50 distinct sounds when processing the audio data. In some cases, adding one or more phonemes into or removing the one or more phonemes from the tokenizer vocabulary.

In some cases, a script that includes the pseudoword that the student is attempting to pronounce is generated as well. Based on the pseudoword in the script and the tokenizer vocabulary, a mapping of a set of phonemes associated with the pseudoword may be determined by the machine-learning model.

According to some examples, the method includes comparing, by the machine-learning model, the phoneme-based transcription to one or more sets of acceptable phonemes associated with the pseudoword at step 806. For example, the custom dictionary construction module 106, the phonetic evaluation service 102, and/or the pre-trained base model 210 of FIGS. 1 and 2 may compare the phoneme-based transcription. In some cases, the one or more sets of acceptable phonemes is determined by querying a phoneme-to-pseudoword custom dictionary. The phoneme-to-pseudoword custom dictionary may include mappings between various pseudowords and one or more sets of acceptable phonemes for pronouncing the respective pseudoword.

According to some examples, the method includes determining, by the machine-learning model, a model score mark for the one pseudoword at step 808. For example, the mapping and assessment module 114, the phonetic evaluation service 102, and/or the pre-trained base model 210 of FIGS. 1 and 2 may determine the model score mark. In some cases, for one or more selected phonemes of the pseudoword, an alignment between the phoneme-based transcription and the one or more sets of phonemes is assessed, and the model score mark reflects the alignment.

For example, a pseudoword BEBSKAY, which may have more than one acceptable pronunciation, may be inputted into the machine-learning model. Phonemes for the pseudoword may be extracted, which may involve breaking down the word into its constituent sounds and identifying the individual phonemes. For example, in the case of BEBSKAY, the extracted phonemes can be /B/ /EH/ /B/ /S/ /K/ /EY/ and /B/ /IH/ /B/ /S/ /K/ /EY/ (following the example in FIG. 5).

The transcriptions may represent different acceptable pronunciations of the pseudoword, and will serve as the basis for evaluating how accurately a student pronounces the pseudoword. In some cases, an evaluation is directed at particular phonemes and therefore the student does not need to pronounce the whole pseudoword correctly, just the selected phonemes. Therefore, for BEBSKAY, if the evaluation directed at “BE”, the student may pronounce the word as /B/ /EH/ /B/ /S/ /AY/ or /B/ /IH/ /B/ /S/ /EY/ and the machine-learning model may store a correct mark as the model score mark even though the student did not pronounce the word pseudoword correctly.

According to some examples, the method includes receiving a selection of a teacher score mark for one of the one or more pseudowords at step 810. For example, the assessment and editor UI module 116, the phonetic evaluation service 102, and/or the user interface 202 of FIGS. 1 and 2 may receive the selection. The teacher score mark is given by a teacher based on their evaluation of whether or not the student pronounced the selected phonemes of the pseudoword correctly.

According to some examples, the method includes determining that the teacher score mark and the model score mark are different at step 812. For example, the mapping and assessment module 114, the phonetic evaluation service 102, and/or the machine-learning model of FIGS. 1 and 2 may determine that the marks are different. According to some examples, the method includes providing a feedback to a client device indicating that the teacher score mark and the model score mark are different at step 814. In some cases, the feedback is a visual indication associated with the pseudoword that is has differing marks. The visual indication will alert the teacher to review that audio recording the pseudoword to double check whether the teacher is correct or the model.

In some cases, the feedback may be correct or incorrect. Follow-up feedback to refine the model may be provided to a linguist, after the fact, to replay teacher-scored audio, change transcription and scoring where needed, and retrain the model. The follow-up feedback may be provided to the machine-learning model to fine-tune parameters of the machine-learning model to correct a misalignment associated with the feedback. In some cases, the follow-up feedback is one or more tags regarding a reason for the difference. For example, the student may have an accent, and they did not technically pronounce the selected phoneme incorrectly. Selecting a tag associated with teaching the machine-learning model about the accent may be used. Other tags may be used to categorize the misalignment to better assist the machine-learning model in learning how to fine-tune its parameters. In some cases, teacher assessments of queued and replayed audio are over-scored to correct misalignments in an asynchronous reinforcement training loop.

In some cases, the machine-learning model is trained on a preprocessed dataset that includes an audio array, a respective phoneme transcription, and respective audio features. The training may use a loss function to minimize loss. The fine-tuning may further minimize the difference between the teacher score marks and the model score mark by adjusting the parameters of the machine-learning model using gradient descent or other optimization algorithms. The fine-tuning may also involve updating the phonetic evaluation service 102 to better align with the nuances of human speech.

The fine-tuned machine-learning model may effectively handle accent detection or adaptation to different speaking styles. The fine-tuning process may also involve using techniques such as transfer learning, where the pre-trained weights of one model are used as a starting point for another related task. This can help to leverage the knowledge and expertise gained from training on one dataset or task, and to adapt it to new and challenging situations. Additionally, the fine-tuning process may involve incorporating the follow-up feedback from the teachers, who can provide valuable insights and guidance on how to improve the performance of the machine-learning model.

The fine-tune machine-learning model may be continuously trained in an asynchronous process whereby teacher-scored audios are fed into a queue where one or more linguists can verify the accuracy of the transcription and scoring. In some cases, the batched process collects and queues audio from multiple sources, such as school districts, presenting it anonymously to linguists at a later date, outside of the real-time feedback from the machine-learning model to the teacher. The linguistic-accuracy-validated set of transcriptions can then be fed back into the fine-tune machine-learning model as reinforcement learning for improved accuracy, which may also be at a later date.

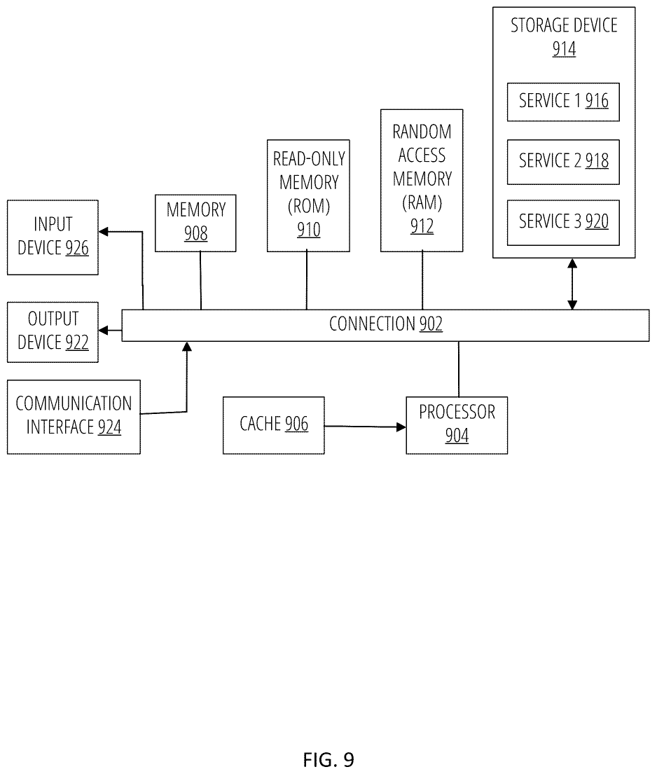

FIG. 9 illustrates a block diagram of an exemplary computing system in accordance with some aspects of the present technology.

The example of computer system 900 can be for example any computing device making up the continuous zero trust platform 100, or any component thereof in which the components of the system are in communication with each other using connection 902. Connection 902 can be a physical connection via a bus, or a direct connection into processor 904, such as in a chipset architecture. Connection 902 can also be a virtual connection, networked connection, or logical connection.

In some embodiments, computer system 900 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 900 includes at least one processing unit (CPU or processor) 904 and connection 902 that couples various system components including system memory 908, such as read-only memory (ROM) 910 and random access memory (RAM) 912 to processor 904. Computing system 900 can include a cache of high-speed memory 908 connected directly with, in close proximity to, or integrated as part of processor 904.

Processor 904 can include any general purpose processor and a hardware service or software service, such as services 916, 918, and 920 stored in storage devices 914, configured to control processor 904 as well as a special-purpose processor where software instructions are incorporated into the actual processor design. Processor 904 may essentially be a completely self-contained computing system, containing multiple cores or processors, a bus, memory controller, cache, etc. A multi-core processor may be symmetric or asymmetric.

To enable user interaction, computer system 900 includes an input device 926, which can represent any number of input mechanisms, such as a microphone for speech, a touch-sensitive screen for gesture or graphical input, keyboard, mouse, motion input, speech, etc. Computing system 900 can also include output device 922, which can be one or more of a number of output mechanisms known to those of skill in the art. In some instances, multimodal systems can enable a user to provide multiple types of input/output to communicate with computer system 900. Computer system 900 can include communication interface 924, which can generally govern and manage the user input and system output. There is no restriction on operating on any particular hardware arrangement, and therefore the basic features here may easily be substituted for improved hardware or firmware arrangements as they are developed.

Storage device 914 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 914 can include software services, servers, services, etc., that when the code that defines such software is executed by the processor 904, it causes the system to perform a function. In some embodiments, a hardware service that performs a particular function can include the software component stored in a computer-readable medium in connection with the hardware components, such as processor 504, connection 502, output device 522, etc., to carry out the function.

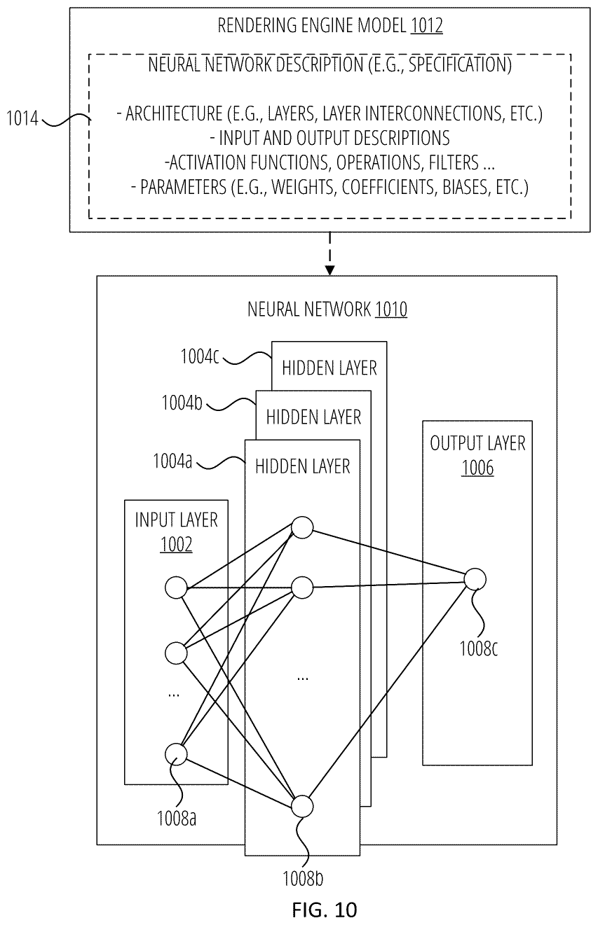

FIG. 10 illustrates an example neural network architecture in accordance with some aspects of the present technology.

Architecture 1000 includes a neural network 1010 defined by an example neural network description 1014 in node 1008c (neural controller). The neural network 1010 can represent a neural network implementation of a rendering engine for rendering media data. The neural network description 1014 can include a full specification of the neural network 1010, including the neural network architecture 1000. For example, the neural network description 1014 can include a description or specification of the architecture 1000 of the neural network 1010 (e.g., the layers, layer interconnections, number of nodes in each layer, etc.); an input and output description which indicates how the input and output are formed or processed; an indication of the activation functions in the neural network, the operations or filters in the neural network, etc. ; neural network parameters such as weights, biases, etc.; and so forth.

The neural network 1010 reflects the architecture 1000 defined in the input layer 1002. In this example, the neural network 1010 includes an input layer 1002, which includes input data, such as an audio recording, audio data and a script that includes the pseudoword(s) that a student is attempting to pronounce in the audio recording. In one illustrative example, the input layer 1002 can include data representing a portion of the input media data such as the audio recording. The neural network 1010 includes hidden layers 1004a through 804 N (collectively “804” hereinafter). The hidden layers 804 can include n number of hidden layers, where n is an integer greater than or equal to one. The number of hidden layers can include as many layers as needed for a desired processing outcome and/or rendering intent.

The neural network 1010 further includes an output layer 1006 that provides an output (e.g., rendering output) resulting from the processing performed by the hidden layers 804. In one illustrative example, the output layer 806 can provide a determination of a model score mark and/or a feedback indicating a difference between a teacher score mark and the model score mark. The neural network 1010 in this example is a multi-layer neural network of interconnected nodes. Each node can represent a piece of information. Information associated with the nodes is shared among the different layers and each layer retains information as information is processed. In some cases, the neural network 1010 can include a feed-forward neural network, in which case there are no feedback connections where outputs of the neural network are fed back into itself. In other cases, the neural network 1010 can include a recurrent neural network, which can have loops that allow information to be carried across nodes while reading in input. Information can be exchanged between nodes through node-to-node interconnections between the various layers.

Nodes of the input layer 1002 can activate a set of nodes in the first hidden layer 1004a. For example, as shown, each of the input nodes of the input layer 1002 is connected to each of the nodes of the first hidden layer 1004a. The nodes of the hidden layers hidden layer 1004a can transform the information of each input node by applying activation functions to the information. The information derived from the transformation can then be passed to and can activate the nodes of the next hidden layer (e.g., 1004b), which can perform their own designated functions. Example functions include convolutional, up-sampling, data transformation, pooling, and/or any other suitable functions. The output of the hidden layer (e.g., 1004b) can then activate nodes of the next hidden layer (e.g., 604N) , and so on. The output of the last hidden layer can activate one or more nodes of the output layer 1006, at which point an output is provided. In some cases, while nodes (e.g., nodes 1008a, 1008b, 1008c) in the neural network 1010 are shown as having multiple output lines, a node has a single output and all lines shown as being output from a node represent the same output value. In some cases, each node or interconnection between nodes can have a weight that is a set of parameters derived from training the neural network 1010.

For example, an interconnection between nodes can represent a piece of information learned about the interconnected nodes. The interconnection can have a numeric weight that can be tuned (e.g., based on a training dataset), allowing the neural network 1010 to be adaptive to inputs and able to learn as more data is processed. The neural network 1010 can be pre-trained to process the features from the data in the input layer 1002 using the different hidden layers 804 in order to provide the output through the output layer 1006. In an example in which the neural network 1010 is used to identify the machine-learning factors, the neural network 1010 can be trained using training data that includes generated machine-learning factors, the stored current features, and the stored historical features including at least one of audio recordings and respective transcriptions, pre-processed training data including respective phonemes associated with respective words or pseudowords, an audio array, phoneme transcriptions, and/or audio features. For instance, training data can be input into the neural network 1010, which can be processed by the neural network 1010 to generate outputs which can be used to tune one or more aspects of the neural network 1010, such as weights, biases, etc. In some cases, the neural network 1010 can adjust weights of nodes using a training process called backpropagation. Backpropagation can include a forward pass, a loss function, a backward pass, and a weight update. The forward pass, loss function, backward pass, and parameter update is performed for one training iteration.

The process can be repeated for a certain number of iterations for each set of training media data until the weights of the layers are accurately tuned. For a first training iteration for the neural network 1010, the output can include values that do not give preference to any particular class due to the weights being randomly selected at initialization. With the initial weights, the neural network 1010 is unable to determine low level features and thus cannot make an accurate determination of what the classification of the object might be. A loss function can be used to analyze errors in the output. Any suitable loss function definition can be used. The loss (or error) can be high for the first training dataset since the actual values will be different than the predicted output.

The goal of training is to minimize the amount of loss so that the predicted output comports with a target or ideal output. The neural network 1010 can perform a backward pass by determining which inputs (weights) most contributed to the loss of the neural network 1010, and can adjust the weights so that the loss decreases and is eventually minimized. A derivative of the loss with respect to the weights can be computed to determine the weights that contributed most to the loss of the neural network 1010. After the derivative is computed, a weight update can be performed by updating the weights of the filters. For example, the weights can be updated so that they change in the opposite direction of the gradient. A learning rate can be set to any suitable value, with a high learning rate including larger weight updates and a lower value indicating smaller weight updates.

The neural network 1010 can include any suitable neural or deep learning network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. In other examples, the neural network 1010 can represent any other neural or deep learning network, such as an autoencoder, a deep belief nets (DBNs), a recurrent neural networks (RNNs), etc.

What is claimed is:

1. A computer-implemented method for machine learning-based phonetics evaluation, the computer-implemented method comprising:
receiving audio data of a student attempting to pronounce a pseudoword;
processing the audio data using a machine-learning model to determine a phoneme-based transcription of the audio data;
comparing, by the machine-learning model, the phoneme-based transcription to one or more sets of acceptable phonemes associated with the pseudoword;
determining, by the machine-learning model, a model score mark based on the comparing;
receiving a selection of a teacher score mark for the pseudoword;
determining that the teacher score mark and the model score mark are different; and
providing a feedback to a client device indicating that the teacher score mark and the model score mark are different.

2. The computer-implemented method of claim 1, wherein the machine-learning model processes a script that includes the pseudoword.

3. The computer-implemented method of claim 2, further comprising:
querying, by the machine-learning model, a phoneme-to-pseudoword custom dictionary to identify the one or more sets of acceptable phonemes for pronouncing the pseudoword included in the script.

4. The computer-implemented method of claim 2, wherein the script is used as a a queuing mechanism that indicates that a new record has been inserted for processing.

5. The computer-implemented method of claim 1, wherein the comparing includes:
for one or more selected phonemes of the pseudoword, assessing an alignment between the phoneme-based transcription and the one or more sets of acceptable phonemes, wherein the model score mark reflects the alignment.

6. The computer-implemented method of claim 1, further comprising:
receiving a new phoneme insertion, or a new phoneme replacement, or a phoneme deletion for the pseudoword based on a selection in a graphical user interface of a transcription editor; and
changing a stored phoneme transcription of the pseudoword.

7. The computer-implemented method of claim 1, wherein the model score mark is a correct mark or an incorrect mark.

8. The computer-implemented method of claim 1, further comprising:
add a timestamp to the phoneme in the audio data; and
using the timestamp for playback of the phoneme at the client device.

9. The computer-implemented method of claim 1, further comprising:
receiving one or more tags; and
sending the one or more tags to the machine-learning model to fine-tune parameters of the machine-learning model to correct a misalignment associated with the one or more tags.

10. The computer-implemented method of claim 1, further comprising:
over-scoring teacher assessments of queued and replayed audio to correct misalignments in an asynchronous reinforcement training loop.

11. The computer-implemented method of claim 1, wherein the processing the audio data to determine the phoneme-based transcription uses a tokenizer vocabulary that represents a mapping between audio inputs and corresponding phonemes.

12. The computer-implemented method of claim 11, further comprising:
adding one or more phonemes into or removing the one or more phonemes from the tokenizer vocabulary.

13. The computer-implemented method of claim 1, further comprising:
training the machine-learning model on a preprocessed dataset that includes an audio array, a respective phoneme transcription, and respective audio features, wherein the training uses a loss function to minimize loss.

14. The computer-implemented method of claim 1, further comprising:
receiving pre-processed audio data of the student reading the pseudoword and a teacher speaking; and
performing speaker diarization on the pre-processed audio data, wherein the audio data of the student reading one or more pseudowords is isolated from audio data of the teacher speaking.

15. A system comprising:
a processor; and
a memory storing instructions that, when executed by the processor, configure the system to:
receive audio data of a student attempting to pronounce a pseudoword;
process the audio data using a machine-learning model to determine a phoneme-based transcription of the audio data;
compare, by the machine-learning model, the phoneme-based transcription to one or more sets of acceptable phonemes associated with the pseudoword;
determine, by the machine-learning model, a model score mark based on the comparing;
receive a selection of a teacher score mark for the pseudoword;
determine that the teacher score mark and the model score mark are different; and
provide a feedback to a client device indicating that the teacher score mark and the model score mark are different.

16. The system of claim 15, wherein the machine-learning model processes a script that includes the pseudoword.

17. The system of claim 16, wherein the instructions further configure the apparatus to:
query, by the machine-learning model, a phoneme-to-pseudoword custom dictionary to identify the one or more sets of acceptable phonemes for pronouncing the pseudoword included in the script.

18. The system of claim 15, wherein the comparing includes:
for one or more selected phonemes of the pseudoword, assess an alignment between the phoneme-based transcription and the one or more sets of acceptable phonemes, wherein the model score mark reflects the alignment.

19. The system of claim 15, wherein the instructions further configure the apparatus to:
receive a new phoneme insertion, or a new phoneme replacement, or a phoneme deletion for the pseudoword based on a selection in a graphical user interface of a transcription editor; and
change a stored phoneme transcription of the pseudoword.

20. A non-transitory computer-readable storage medium, the computer-readable storage medium including instructions that when executed by one or more processors, cause the one or more processors to:
receive audio data of a student attempting to pronounce a pseudoword;
process the audio data using a machine-learning model to determine a phoneme-based transcription of the audio data;
compare, by the machine-learning model, the phoneme-based transcription to one or more sets of acceptable phonemes associated with the pseudoword;
determine, by the machine-learning model, a model score mark based on the comparing;
receive a selection of a teacher score mark for the pseudoword;
determine that the teacher score mark and the model score mark are different; and
provide a feedback to a client device indicating that the teacher score mark and the model score mark are different.
